(19) United States
(12) Patent Application Publication
(10) Pub. No.: US 2016/0080898 A1
(43) Pub. Date: Mar. 17, 2016

(54) PROXIMITY COMMUNICATION METHOD

(71) Applicant: LFKO Limited, Surrey (GB)

(72) Inventor: Jae Kyun OH, London (GB)

(21) Appl. No.: 14/855,676

(22) Filed: Sep. 16, 2015

(30) Foreign Application Priority Data
Sep. 16, 2014 (GB) 1416306.7

(51) Int. Cl. H04W 4/02; H04W 64/00

(52) U.S. Cl. CPC H04W 4/02; H04W 64/00

(57) ABSTRACT

A method of handling communication between devices 2, 4, 6, 8, comprises receiving the location of a first device 2; receiving the locations of a plurality of second devices 4, 6, 8; receiving a request from the first device 2 including a message for transmission and at target area 12; responsive to receiving the request from the first device 2, determining whether the location of one or more of the second devices 4 is within the transmission area 12 at the time of sending of the request; and responsive to determining that one or more of the second devices 4 is within the transmission area 12, transmitting the message to those second devices 4.

### CROSS-REFERENCE TO RELATED APPLICATIONS

The present application claims priority from United Kingdom Patent Application No. 1416306.7, the content of which is incorporated herein by reference.

### TECHNICAL FIELD

The present invention relates to communication between devices, and particularly to communication between two devices based on their relative locations.

### BACKGROUND OF THE INVENTION

Traditionally, communication between devices has required either the sender or the recipient to actively know the other party to the communication. For example, in the case of email and text messaging, the sender must actively select the recipient(s) of the message. Alternatively, in the case of mailing lists or blogs, the recipient must actively subscribe in order to receive specific content.

This restriction means that, when in a new location, users need to add friends or build network in order to connect with people having local knowledge, which may not always be practical.

Local bulletin board type services also exist, in which users within a certain pre-set area are allowed to post to a bulletin board, and new users entering the area are then able to see posts to the board. However, posts to bulletin boards may be out of date. Furthermore, the pre-set area that the bulletin board covers may not be most suited for the user where the user is not near the centre of the board, or where the area is too large or too small.

At least the preferred embodiments of the present invention seek to solve some of the problems discussed above.

### SUMMARY OF THE INVENTION

The present invention provides a method of handling communication between devices, comprising: receiving the location of a first device; receiving the locations of a plurality of second devices; receiving a request from the first device including a message for transmission; responsive to receiving the request from the first device, determining an area surrounding the location of the first device and determining whether one or more of the second devices satisfies one or more criteria, the criteria including at least that the location of the second device is within the determined area at the time of sending of the request; and responsive to determining that one or more of the second devices satisfies the criteria, transmitting or making available the message to the second devices satisfying the criteria.

The present invention provides a new communication method that mimics the shout of a user of the first device. The user can thus communicate in a new manner with those around them, to obtain relevant local information. The users of the second device either receive the message directly, or where the message is stored centrally, receive for example permission to read the message. The method of this aspect is preferably carried out on a host server. The locations are preferably received from client programs running on the first and second devices.

In one embodiment the request includes data for determining a target area, and the determined area is the target area. Thus, the user sending the message may select the range of their message themselves.

In another embodiment, the determined area may be determined based on a rank associated with the first device or a user of the first device. For example, the determined area may increase with increasing rank of the user or device. This allows users that have been assigned a higher rank to communicate over a larger are than those of lower rank. By limiting the range of certain users, users of lower ranks (for example, users who have been identified as posting excessively or as posting poor content) have restricted range, thus ensuring that the messages received by the second devices are as useful as possible.

In a preferred aspect of this embodiment, the request may include data for determining a target area, and the one or more criteria may then further include that the location of the second device is within the target area at the time of sending of the request. Thus, as above, although the maximum range of the user/device may be limited, the user still has the option to broadcast over a smaller area. This allows users to select, within their maximum range, how far they wish to broadcast their message.

Preferably, the method may further comprise receiving a positive or negative feedback from the user of a second device that received the message and adjusting the rank of the first device or the user of the first device based on the feedback. Thus, users of the second devices can provide feedback about the user of the first device, whose rank (and hence maximum range) is then adjusted accordingly.

In one embodiment, the target area may be limited by the first device to a maximum target area based on the rank associated with the first device or a user of the first device, preferably wherein the area increases with increasing rank. Thus, the limitation based on rank may be, for example, performed locally by the first device rather than centrally by the server.

In one mode of operation, the message is preferably transmitting or made available to substantially all of the second devices having a location within the determined area at the time of sending of the request. That is to say, the message is broadcast to all devices running the client program within the determined area. Thus, in this mode, the plurality of second devices includes substantially all devices transmitting their location to a server.

In this mode of operation, the message is broadcast freely to all users able to receive the message, i.e. receipt of the message is not limited to a subset of second devices, for example to receipt by devices used by friends of the user of the first device. Thus, a user can communicate with all available users in their vicinity without needing to first establish a network of local contacts.

In this context, the term “substantially all” is intended to generally include all devices capable of receiving messages, i.e. all except where a device is unable to receive messages, for example due to a fault or due to a user of the device having their service suspended.

In some embodiments, in another mode of operation, the request may define one or more recipient requirements and the one or more criteria further includes that the second device satisfies the one or more requirements. The user for the first device may then select, to a certain extent, those who receive the message.

For example, the one or more requirements may include that the second device or a user of the second device is one of a pre-determined list of devices or users. Thus, for example, the user may choose to send messages only to a list of “friends” who are within the determined radius.

In further embodiments, the user may be able to select to send messages to the second devices based on the gender of the user of the device. For example, the one or more requirements may include that a user of the second device is of a selected gender.

Although any shaped area may be used, the determined and/or target area is a preferably a substantially circular area centred on the location of the first device. Of course, other possibilities could be used, for example geographical areas such as countries, states, counties, cities, or the like. However, a substantially circular area allows the user to select the distance for their messages so as to extend effectively the same distance in all directions, which provides in most situations optimal contact with people in the same locality.

Whilst a static device, such as a personal computer could be used, the first device is preferably a mobile device, such as a mobile phone or tablet. Such devices typically include the necessary hardware for determination of their own location, as well as for transmission and receipt of signals.

Transmission and receipt of the signals by the first and/or second devices may be by any suitable means, for example over the internet or via a Wi-Fi connection. Determination of the location of the first and/or second devices may also be performed by any suitable means, such as by GPS location or by triangulation based on wireless access points and/or mobile phone masts. Of course, it will be understood that the location sent by the device will be only as accurate as the means used to determine the location, and so the location may not be the true location of the device, depending upon the accuracy of the means.

The present invention allows users to communicate with anyone running a suitable client program within the determined area. As such, the second users do not have to have subscribed to receive messages from the first user. This allows a new user to immediately communicate with other users in a new location.

Similarly, the first user need not address the message specifically to the second devices to which it is transmitted. Instead, the message is simply broadcasted to all users (satisfying any other requirements, such as those described above), thus allowing the first user to communicate without need to know people in their vicinity.

The present invention is distinct from local message boards, which are essentially short-term subscription services, in that the message is immediately transmitted or made available to those users in the vicinity, without being stored to a message board that the users must access subsequently. Indeed, the message is preferably transmitted and subsequently visible only to the second devices having a location within the determined area at the time of the request, i.e. users entering the determined area after the time of the request are unable to view the message.

In addition to the above method, the present invention can also be seen to provide a computing device, such as a server, comprising a memory and a processor, the memory storing computer readable instructions that, when executed, will cause the processor to perform the method described above, and optionally any or all of the preferred features of the method.

The present invention also extends to a computing program product comprising computer readable instructions that, when executed, will cause a processor of a computing device to perform the method described above, and optionally any or all of the preferred features of the method. In some embodiments, the computer program product may be stored in a non-transient computer-readable medium.

Another aspect of the present invention provides a mobile communications device comprising a memory, a processor, a transmitter, a receiver and location determination logic, the memory storing computer-readable instructions that, when executed, will cause the processor to perform a method comprising the steps of: when operating in a transmission mode of operation, determining a location of the mobile communications device using the location determination logic; receiving a message for transmission from a user to a plurality of other devices within an area surrounding the mobile communications device; and transmitting a request to a server using the transmitter, the request comprising the determined location of the mobile communications device and the message for transmission; and when operating in a receiving mode of operation, periodically determining a location of the mobile communications device using the location determination logic and transmitting the determined location of the mobile communications device to the server using the transmitter; and receiving a message using the receiver from the server, the message being sent from another device located within the vicinity of the mobile communications device.

Preferably the method further comprises receiving a target transmission area from the user, wherein the request further includes data for determining the target transmission area. In one embodiment, the method further comprises receiving a rank from the server, wherein the target transmission area of the user is limited to a maximum target transmission area based on the rank received from the server.

The present invention also provides a computer program product comprising computer readable instructions for cause the processor of a mobile communications device to perform the steps of the above method.

These and other features of the present application and the resultant patent will become apparent to one of ordinary skill in the art upon review of the following detailed description when taken in conjunction with the several drawings and appended claims.

### BRIEF DESCRIPTION OF THE DRAWINGS

Certain preferred embodiments of the present invention will now be described in greater detail, by way of example only and with reference to the accompanying drawings, in which:

FIG. 1 shows schematically a network including a transmitting device, a server and a plurality of receiving devices;

FIG. 2 shows a transmission interface;

FIG. 3 shows a receiving interface;

FIG. 4 shows a detailed information interface; and

FIG. 5 shows a map of a first transmitting device and a plurality of surrounding receiving devices.

### DETAILED DESCRIPTION

The following disclosure relates to a method of communication between mobile communications devices. By way of summary, the method mimics a physical shout, so that a message broadcast by a user will be “heard” by everyone within their selected geographical range.

The invention is embodied in software executed on client communications devices and a host server. Communication between the communications devices in accordance with the present invention is performed through the host server. The software on the devices and server allow users of the communications devices to communicate in a novel manner providing a novel communication technique for users.

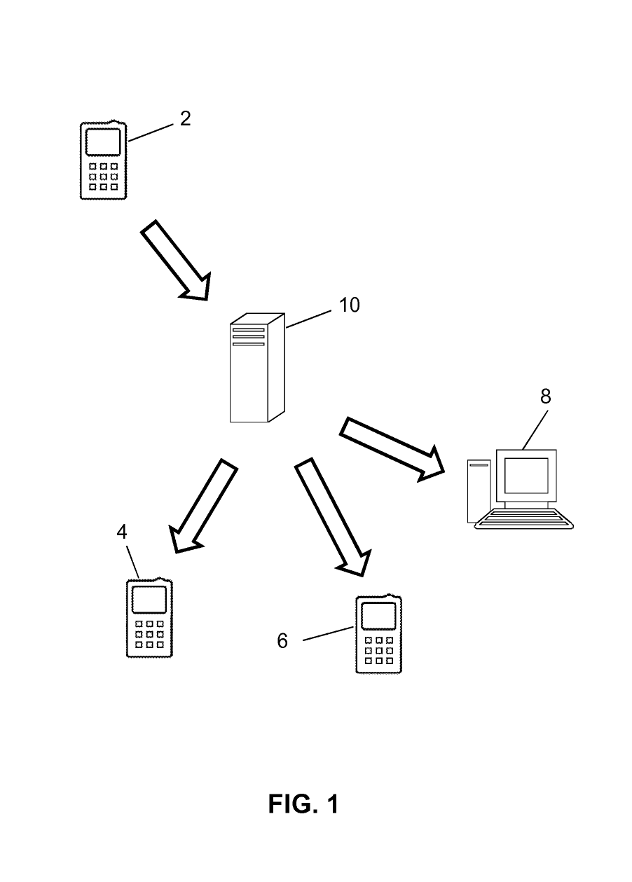

FIG. 1 illustrates an exemplary configuration in which a first mobile communication device 2 communicates with a plurality of second devices 4, 6, 8 via a server 10. Communication between the devices 2, 4, 6, 8 and the server 10 may be by any suitable means, but is preferably performed using the internet.

The communications devices 2, 4, 6, 8 are preferably mobile phones, such as devices 2, 4 and 6, but the method may also be performed on other devices such as a personal computer 8. The communications devices 2, 4, 6, 8 can preferably operate in both a transmitting mode and a receiving mode (typically concurrently), but for the following discussion, communications device 2 will be illustrated as transmitting and communications devices 4, 6, 8 will be illustrated as receiving.

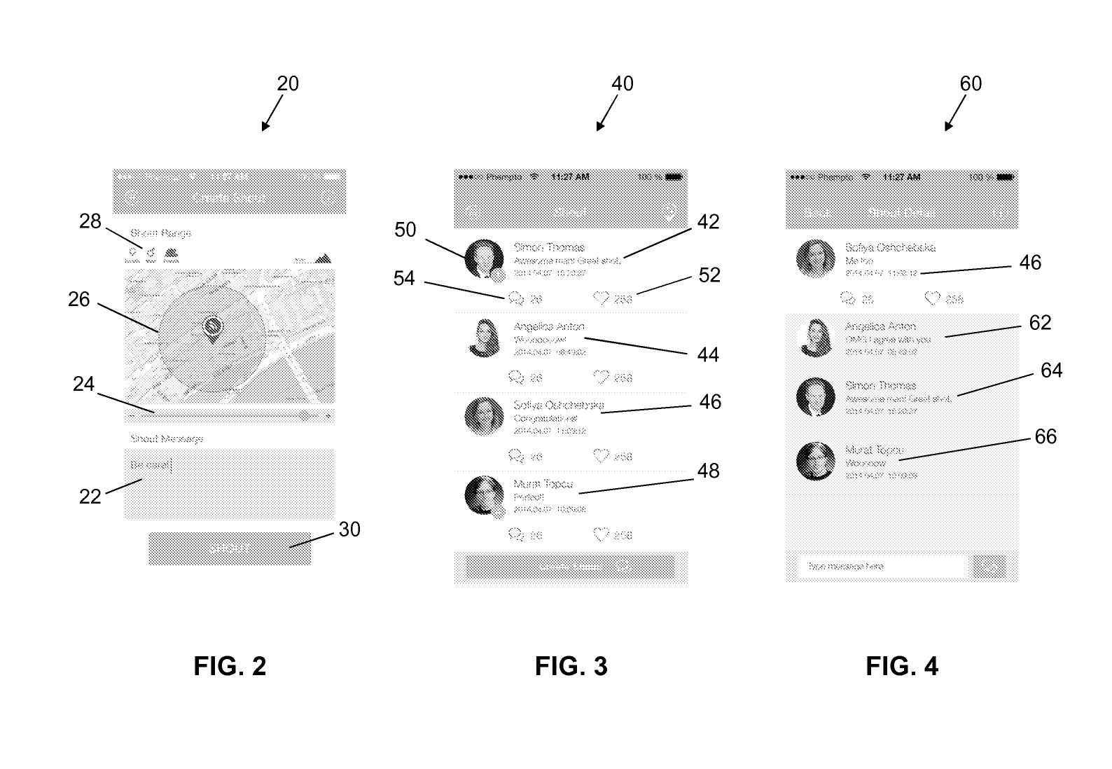

Communication is initiated by the first mobile communications device 2. This may be done, for example, using the input interface 20 shown in FIG. 2.

The user of the first mobile communications device 2 can enter a message to be transmitted into the message input box 22. The user then selects a target radius for transmission using, for example, the radius slider 24. For ease of use, the area encompassed by the selected transmission radius may be displayed as a visible area 26 superimposed on a map of the user's surroundings.

In addition to selecting the transmission radius of the message, the user may optionally further select one or more criteria to be met by the recipient in order to receive the message. These criteria may be selected, for example, using shortcut buttons 28 on the interface 20. Exemplary criteria may include the gender of the recipient, i.e. male or female, or that the recipient is in a list of users created by the user of the first device, such as a “friends” list or the like. However, the use of these criteria is not essential and the user can select to simply broadcast the message to all devices within the selected radius.

When the user of the first mobile communications device 2 is satisfied with their message and transmission requirements, they may broadcast the message by pressing a send button 30. A request in then sent to the server 10 requesting transmission of the message to nearby devices 4, 6, 8. The request includes the message for transmission, the location of the first communications device 2, area data sufficient to identify the target transmission area (e.g. a transmission radius), and any additional requirements set by the user. The request may also include information identifying either the first communications device 2 or the user of the first communications device 2.

When active, the communications devices 4, 6, 8 operating in a receiving mode will periodically determine their own location and transmit their locations to the server 10. The received locations of the second devices 4, 6, 8 are stored on the server 10 and updated when a new location of the respective device 4, 6, 8 is received.

Upon receiving a request from the first device 2 the server 10 determines the transmission area based on the location of the device 2 and the area data.

The server 10 then determines which second devices 4, 6, 8 are located within the determined transmission area and once these second devices 4 are identified, the server 10 applies any further requirements by the user so as to create a list of second devices 4, 6, 8 to which the message will be transmitted. The order in which these criteria are applied is not limited to this order and they may be applied in a different order. The message is then transmitted directly to those devices 4, 6, 8 that satisfy all of the criteria for receipt of the message. The message may be stored on the server 10 and the devices 4, 6, 8 that satisfy all of the criteria for receipt of the message may instead or in addition receive authorisation to access the message.

FIG. 3 shows an example of a receiving interface 40. The receiving interface 40 shows the messages 42, 44, 46, 48 received by one of the second communications device 4, 6, 8. The messages displayed are unique to each device depending on where it was when the messages were sent, i.e. if the device was out of range of a message, then the user of the device cannot see that message because the messages are visible only to devices within the determined area at the time the request is processed. Users coming into the area subsequently cannot see the original message.

Preferably the message remains stored centrally on the host server 10, such that recipients can respond to the message. For example, the receiving interface 40 may additionally show further information about the message, for example the sender 50, the number of users 52 that have “liked” the message and the number of users that have replied to the message 54. However the message remains visible only to those within the area at the time of sending.

FIG. 4 shows a detailed information interface 60. In this interface 60, further details regarding a specific message 46 are visible, such as replies 62, 64, 66 to the message 46.

Users receiving a message are provided with an option to give feedback on the message. This may be either positive feedback, for example by “liking” the message, or negative feedback, for example by “disliking” the message. This feedback is returned to the server 10.

Upon receipt of positive or negative feedback, the server will make a record of the feedback, for example against the user and/or the specific message. Each user has a rank, which determines their maximum transmission distance. As the user receives more positive feedback, this rank may be increased allowing them to transmit to a larger audience. Conversely, if a user receives more negative feedback, this rank may be decreased, thereby reducing their ability to transmit to larger audiences. The rank of a user may of course also be adjusted in other ways.

The rank of a user may be transmitted to their communications device 2 so that the client software on their device 2 will limit the maximum transmission area the user is able to select. Alternatively, the limit may be applied at the server 10 side, for example if the user selects a transmission area greater than their maximum allowed area, then the server 10 will limit their range to the maximum allowed by the user's rank. A user's maximum allowable area will increase with increased rank, although the relationship may not necessarily be linear.

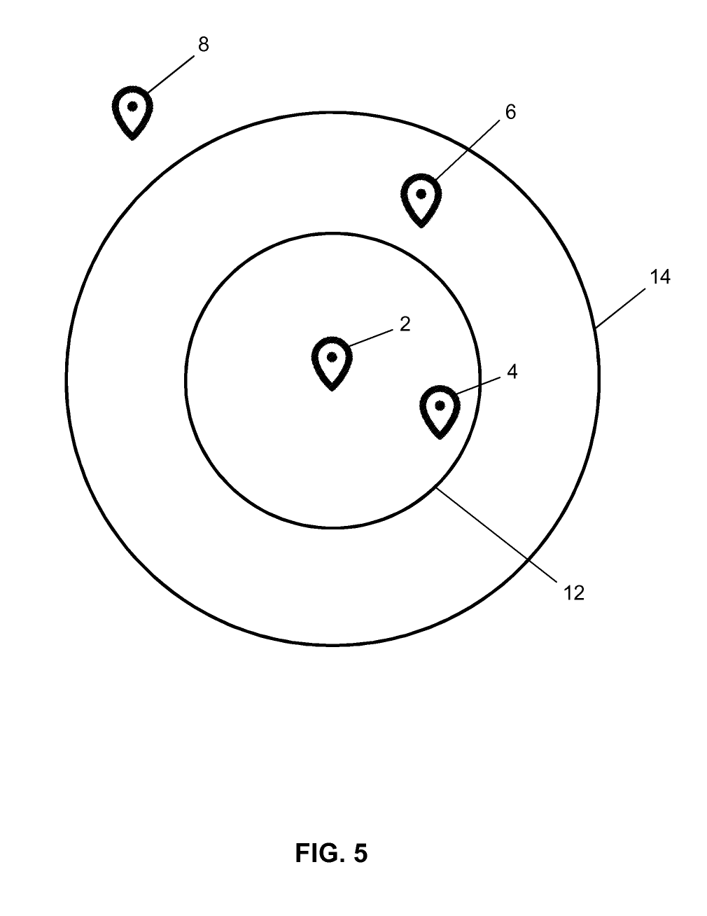

FIG. 5 shows an exemplary arrangement of three receiving devices 4, 6, 8 surrounding a transmitting device 2. The maximum allowable transmission area 14 of the transmitting device 2 in not sufficiently large to include device 8, and so the transmitting device cannot communicate with device 8.

Furthermore, the user has selected a transmission area 12 that is smaller than their maximum transmission area 14. This transmission area 12 includes only device 4. So a message sent with this transmission area 12 would not be received by device 6, even though it is within the maximum transmission area.

It should be apparent that the foregoing relates only to the preferred embodiments of the present applicant and the resultant patent. Numerous changes and modifications may be made herein by one of ordinary skill in the art without departing from the general spirit and scope of the invention as defined by the following claims and the equivalents thereof.

We claim:

1. A method of handling communication between devices, comprising:
receiving the location of a first device;
receiving the locations of a plurality of second devices;
receiving a request from the first device including a message for transmission and data for determining a target area;
responsive to receiving the request from the first device, determining an area surrounding the location of the first device, wherein the determined area is determined based on a rank associated with the first device or a user of the first device, preferably wherein the area increases with increasing rank;
determining whether one or more of the second devices satisfies certain criteria, the criteria including at least that the location of the second device is within both the determined area and the target area at the time of sending of the request; and
responsive to determining that one or more of the second devices satisfies the criteria, transmitting or making available the message to the second devices satisfying the criteria.

2. A method according to claim 1, further comprising receiving a positive or negative feedback from the user of a second device that received the message and adjusting the rank of the first device or the user of the first device based on the feedback.

3. A method according to claim 1, wherein the plurality of second devices includes substantially all devices transmitting their location to a server, and wherein, in a first mode of operation, the message is transmitting or made available to substantially all of the second devices having a location within the determined area at the time of sending of the request.

4. A method according to claim 1, wherein, in a second mode of operation, the request further defines one or more recipient requirements and the criteria further include that the second device satisfies the one or more requirements, preferably wherein the criteria include that the second device or a user of the second device is one of a pre-determined set of devices or users.

5. A method according to claim 1, wherein the message is visible only to the second devices satisfying the criteria at the time of sending the request.

6. A method according to claim 1, wherein the area is a substantially circular area centred on the location of the first device.

7. A method according to claim 1, wherein the first device is a mobile device, and preferably a mobile phone.

8. A method according to claim 1, wherein at least one of the users of the second devices that receives the message has not subscribed to receive messages from the first device or the user of the first device.

9. A method according to claim 1, wherein the user of the first device has not addressed the message specifically to the second devices to which it is transmitted.

10. A method of handling communication between devices, comprising:
receiving the location of the first device;
receiving the locations of a plurality of second devices;
receiving a request from the first device including a message for transmission and data for determining a target area, the target area having been limited by the first device so as not to exceed a maximum area determined based on a rank associated with the first device or a user of the first device, preferably wherein the area increases with increasing rank;
responsive to receiving the request from the first device, determining an area surrounding the location of the first device, wherein the determined area is the target area;
determining whether one or more of the second devices satisfies one or more criteria, the criteria including at least that the location of the second device is within the determined area at the time of sending of the request; and
responsive to determining that one or more of the second devices satisfies the criteria, transmitting or making available the message to the second devices satisfying the criteria.

11. A method according to claim 10, further comprising:
receiving a positive or negative feedback from the user of a second device that received the message;
adjusting a rank of the first device or the user of the first device based on the feedback; and
transmitting the adjusted rank to the first device.

12. A method according to claim 10, wherein the plurality of second devices includes substantially all devices transmitting their location to a server, and wherein, in a first mode of operation, the message is transmitting or made available to substantially all of the second devices having a location within the determined area at the time of sending of the request.

13. A method according to claim 10, wherein, in a second mode of operation, the request further defines one or more recipient requirements and the criteria further include that the second device satisfies the one or more requirements, preferably wherein the criteria include that the second device or a user of the second device is one of a pre-determined set of devices or users.

14. A method according to claim 10, wherein the message is visible only to the second devices satisfying the criteria at the time of sending the request.

15. A method according to claim 10, wherein the area is a substantially circular area centred on the location of the first device.

16. A method according to claim 10, wherein the first device is a mobile device, and preferably a mobile phone.

17. A method according to claim 10, wherein at least one of the users of the second devices that receives the message has not subscribed to receive messages from the first device or the user of the first device.

18. A method according to claim 10, wherein the user of the first device has not addressed the message specifically to the second devices to which it is transmitted.

19. A mobile communications device comprising a memory, a processor, a transmitter, a receiver and location determination logic, the memory storing computer-readable instructions that, when executed, will cause the processor to perform a method comprising the steps of:
when operating in a transmission mode of operation,
determining a location of the mobile communications device using the location determination logic;
receiving a target transmission area surrounding the mobile communications device from a user;
receiving a message for transmission from the user to a plurality of other devices within the target transmission area; and
transmitting a request to a server using the transmitter, the request comprising the determined location of the mobile communications device, data for determining the target transmission area and the message for transmission; and
when operating in a receiving mode of operation,
periodically determining a location of the mobile communications device using the location determination logic and transmitting the determined location of the mobile communications device to the server using the transmitter;
receiving a message using the receiver from the server, the message being sent from another device located within the vicinity of the mobile communications device;
after receiving the message, receiving a positive or negative feedback from the user; and
transmitting the feedback to the server for adjusting a rank associated with the other device or the user of the other device based on the feedback.

20. A mobile communications device according to claim 19, wherein the method further comprises:
receiving a rank from the server, the rank being associated with the mobile communications device or the user of the mobile communications device;
wherein the target transmission area of the user is limited to a maximum target transmission area based on the rank received from the server.
